(19) United States
(12) Patent Application Publication
(10) Pub. No.: US 2018/0126425 A1
(43) Pub. Date: May 10, 2018

(54) APPARATUS AND METHOD FOR CLEANING A GLASS SHEET

(71) Applicant: Corning Incorporated, Corning, NY (US)

(72) Inventors: Hsien Hui Chen, Kaohsiung City (TW); Po Hua Chen, Kaohsiung City (TW); Wen Jia Chen, Taichung City (TW); Hsueh Hung Fu, Hsinchu (TW); Cheng Feng Huang, Changhua (TW); Naiyue Zhou, Painted Post, NY (US)

(21) Appl. No.: 15/570,143

(22) PCT Filed: Apr. 19, 2016
(86) PCT No.: PCT/US16/28201

§ 371 Date: Oct. 27, 2017

Related U.S. Application Data
(60) Provisional application No. 62/154,199, filed on Apr. 29, 2015.

(51) Int. Cl. B08B 3/02; B08B 11/04; C03C 23/00

(52) U.S. Cl. CPC B08B 3/022; B05B 13/0278; C03C 23/0075; B08B 11/04

(57) ABSTRACT

An apparatus for cleaning a glass sheet moving along a conveyed direction is disclosed herein. The apparatus comprises a first plurality of spraying devices coupled to a water supply and positioned away from a first surface of the glass sheet in a first angle measured from the first surface of the glass sheet, and a control unit configured to supply water from the water supply into the first plurality of spraying devices such that the first plurality of spraying devices spray water from the water supply in a first plurality of spraying sections at the first angle over an edge of the glass sheet, thereby forming a first cleaning zone on the first surface of the glass sheet.

This application claims the benefit of priority under 35 U.S.C. § 119 of U.S. Provisional Application Ser. No. 62/154,199 filed on Apr. 29^{th} 2015, the content of which is relied upon and incorporated herein by reference in its entirety.

### BACKGROUND

The disclosure relates to methods and apparatus for manufacturing glass sheets, and more particularly to methods and apparatus for cleaning glass sheets to reduce the defects in the glass sheets generated during the manufacturing of the glass sheets.

The fusion process is one of the techniques used to produce sheets of glass and can produce sheets of glass having surfaces with superior flatness and smoothness. As a result, the fusion process has found advantageous use in the production of the glass substrates used in the manufacture of light emitting displays, such as liquid crystal displays (LCDs).

The manufacturing of glass sheets involves various processes, including cutting, grinding, polishing or the like. During these processes, a glass sheet is brought to a desired shape by the application of force or friction. Such processes generate a large amount of fragments or chips of glass that may adhere to the surface of the glass sheet, thereby resulting in a defective glass sheet. The fragments or chips of glass adhering to the surface of the glass sheet may degrade the mechanical and optical properties of the glass sheet and may cause some issues for subsequent applications in display devices.

Thus, there is a need for an apparatus or a method for reducing the amount of defects such as adhered glass during the manufacturing of glass sheets.

### SUMMARY

The disclosure provides an apparatus for cleaning a glass sheet moving along a conveyed direction. The apparatus comprises a first plurality of spraying devices coupled to a water supply and positioned away from a first surface of the glass sheet in a first angle measured from the first surface of the glass sheet. The apparatus further comprises a control unit configured to supply water from the water supply into the first plurality of spraying devices, such that the first plurality of spraying devices spray water from the water supply in a first plurality of spraying sections at the first angle over an edge of the glass sheet, thereby forming a first cleaning zone on the first surface of the glass sheet, wherein the first plurality of the spraying sections intersect the first surface of the glass sheet at a first spraying line, the first spraying line and the edge of the glass sheet form a second angle, and the edge is parallel to the conveyed direction.

In one embodiment, the first plurality of spraying devices comprise a first plurality of nozzles, and the first plurality of spraying sections are sectors in a range from about 60 degrees to about 70 degrees. For example, the first plurality of spraying sections are sectors of substantially 65 degrees.

In a further embodiment, a distance between a tip of the first plurality of nozzles and the first surface of the glass sheet is in a range from about 20 mm to about 30 mm. For example, the distance is substantially 25 mm.

In one embodiment, the first angle is in a range from about 10 degrees to about 20 degrees.

In one embodiment, the second angle is in a range from about 10 degrees to about 30 degrees. In a further embodiment, the second angle is substantially 20 degrees.

In one embodiment, a distance between the first spraying line and the edge of the glass sheet is in a range of about 100 mm to about 150 mm.

In another embodiment, the apparatus further comprises a second plurality of spraying devices fluidly coupled to the water supply and positioned away from a second surface of the glass sheet in the first angle measured from the second surface of the glass sheet. The control unit is further configured to supply the water from the water supply into the second plurality of spraying devices such that the second plurality of spraying devices spray the water in a second plurality of spraying sections at the first angle over the edge of the glass sheet, thereby forming a second cleaning zone on the second surface of the glass sheet. The second plurality of spraying sections intersect the second surface of the glass sheet at a second spraying line, the second spraying line and the edge of the glass sheet form a third angle.

In one embodiment, the third angle is in a range from about 85 degrees to about 95 degrees. For example, the third angle is substantially 90 degrees.

In one embodiment, the second plurality of spraying devices comprise a second plurality of nozzles, the second plurality of spraying sections are sectors in a range from about 60 degrees to about 70 degrees, and a distance between a tip of the second plurality of nozzles and the second surface of the glass sheet is in a range from about 20 mm to about 30 mm. For example, the second plurality of spraying sections are sectors of substantially 65 degrees. For example, the distance is substantially 25 mm.

In one embodiment, a number of the first plurality of nozzles is larger than a number of the second plurality of nozzles.

In one embodiment, the apparatus further comprises a conveyor for delivering the glass sheet along the conveyed direction.

The disclosure also provides a method for cleaning a glass sheet moving along a conveyed direction. The method comprises positioning a first plurality of spraying devices coupled to a water supply away from a first surface of the glass sheet in a first angle measured from the first surface of the glass sheet. The method further comprises spraying, through the first plurality of spraying devices, water from the water supply in a first plurality of spraying sections at the first angle over an edge of the glass sheet, thereby forming a first cleaning zone on the first surface of the glass sheet, wherein the first plurality of the spraying sections intersect the first surface of the glass sheet at a first spraying line, the first spraying line and the edge of the glass sheet form a second angle, and the edge is parallel to the conveyed direction.

In one embodiment, the first plurality of spraying devices comprise a first plurality of nozzles, and the first plurality of spraying sections are sectors in a range from about 60 degrees to about 70 degrees. For example, the first plurality of spraying sections are sectors of substantially 65 degrees.

In a further embodiment, a distance between a tip of the first plurality of nozzles and the first surface of the glass sheet is in a range from about 20 mm to about 30 mm. For example, the distance is substantially 25 mm.

In one embodiment, the first angle is in a range from about 10 degrees to about 20 degrees.

In one embodiment, the second angle is in a range from about 10 degrees to about 30 degrees. In a further embodiment, the second angle is substantially 20 degrees.

In one embodiment, a distance between the first spraying line and the edge of the glass sheet is in a range of about 100 mm to about 150 mm.

In another embodiment, the method further comprises positioning a second plurality of spraying devices coupled to the water supply away from a second surface of the glass sheet in the first angle measured from the second surface of the glass sheet, and spraying, through the second plurality of spraying devices, the water in a second plurality of spraying sections at the first angle over the edge of the glass sheet, thereby forming a second cleaning zone on the second surface of the glass sheet, wherein the second plurality of spraying sections intersect the second surface of the glass sheet at a second spraying line, the second spraying line and the edge of the glass sheet form a third angle.

In one embodiment, the third angle is in a range from about 85 degrees to about 95 degrees. For example, the third angle is substantially 90 degrees.

In one embodiment, the second plurality of spraying devices comprises a second plurality of nozzles, the second plurality of spraying sections are sectors in a range from about 60 degrees to about 70 degrees, and a distance between a tip of the second plurality of nozzles and the second surface of the glass sheet is in a range from about 20 mm to about 30 mm. For example, the second plurality of spraying sections are sectors of substantially 65 degrees. For example, the distance is substantially 25 mm.

In one embodiment, a number of the first plurality of nozzles is larger than a number of the second plurality of nozzles.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic view of a glass manufacturing system according to one or more embodiments described herein;

FIG. 2 is a schematic view of an apparatus for machining a glass sheet according to one or more embodiments described herein;

FIG. 3 is a schematic view of a cleaning apparatus for cleaning a glass sheet according to one or more embodiments described herein;

FIG. 4A schematically illustrates a close up view of the cleaning apparatus of FIG. 3 according to one or more embodiments described herein;

FIG. 4B is a schematic side view of FIG. 4A; and

FIG. 5 schematically illustrates a close up view of a cleaning apparatus according to another embodiment described herein.

### DETAILED DESCRIPTION

Reference will now be made in detail to the present preferred embodiment(s), examples of which are illustrated in the accompanying drawings. Whenever possible, the same reference numerals will be used throughout the drawings to refer to the same or like parts.

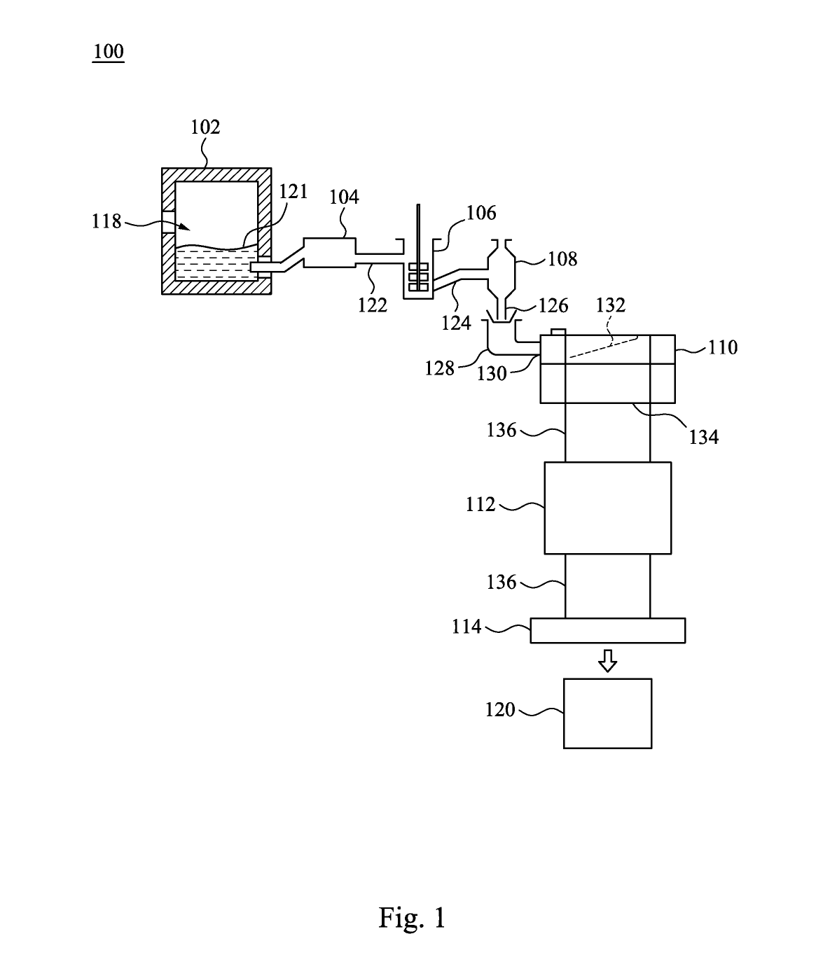

Thin glass sheets can be produced through a fusion process, specifically, an overflow downdraw fusion process. FIG. 1 shows an exemplary embodiment of a glass manufacturing system 100, or a fusion draw apparatus, more specifically, that implements the fusion process for manufacturing a glass sheet 120. The glass manufacturing system 100 may include a melting vessel 102, a fining vessel 104, a mixing vessel 106 (e.g., a stir chamber), a delivery vessel 108, a forming vessel 110, a pull roll assembly 112 and a glass cutting assembly 114.

The glass batch materials are introduced into the melting vessel 102 as shown by arrow 118 and melted to form molten glass 121 in the melting vessel 102. The fining vessel 104 has a high temperature processing area that receives the molten glass 121 from the melting vessel 102 and removes bubbles from the molten glass 121. The fining vessel 104 is connected to the mixing vessel 106 by a fining vessel to mixing vessel connecting tube 122. The mixing vessel 106 is then connected to the delivery vessel 108 by a mixing vessel to delivery vessel connecting tube 124.

The delivery vessel 108 delivers the molten glass 121 through a downcomer 126 to an inlet 128 and into the forming vessel 110. The forming vessel 110 includes an opening 130 that receives the molten glass 121 flowing into a trough 132, and then the molten glass overflows the top of the trough 132 and runs down both sides of the forming vessel 110. The overflow molten glass on the both sides of the forming vessel 110 come together and rejoin at a root 134 before being drawn downward by the pull roll assembly 112 to form the glass ribbon 136. Then, the glass cutting assembly 114 scores the drawn glass ribbon 136 which is then separated into individual glass sheets 120.

The glass sheets may also be obtained from a glass ribbon produced by way of up-draw, float, press rolling, slot draw or other glass forming process techniques. In the float glass processes, a sheet of glass that may be characterized by smooth surfaces and uniform thickness is made by floating molten glass on a bed of molten metal, typically tin. In an exemplary process, molten glass that is fed onto the surface of the molten tin bed forms a floating ribbon. As the glass ribbon flows along the tin bath, the temperature is gradually decreased until a solid glass sheet can be lifted from the tin onto rollers. Once off the bath, the glass sheet can be cooled further and annealed to reduce internal stress.

In the slot draw processes, the molten raw material glass is provided to a drawing tank. The bottom of the drawing tank has an open slot with a nozzle that extends the length of the slot. The molten glass flows through the slot/nozzle and is drawn downward as a continuous sheet and into an annealing region.

It should be understood that the cleaning apparatus and methods disclosed herein are not limited to the glass sheets produced by the processes described above, which are well-known in the art and will not be further described herein.

The glass sheets produced by the suitable methods such as those described above may undergo further machining processes, such as additional cutting, grinding, polishing or the like, which may produce fragments or chips of glass during the processing. During the machining processes, a large amount of fragments or chips of glass may be generated and then attached or adhered to the surface of the glass sheets, which are called “adhered glass.” Such adhered glass attached to the glass sheets has a size in the range of a few microns to about 300 microns. The adhered glass may then migrate toward the center of the glass sheets when the glass sheets are rotated during the processing, and it is difficult to remove the adhered glass by a subsequent washing process, resulting in defective glass sheets. Thus, it is desirable to reduce the amount of adhered glass during the machining processes of the glass sheets.

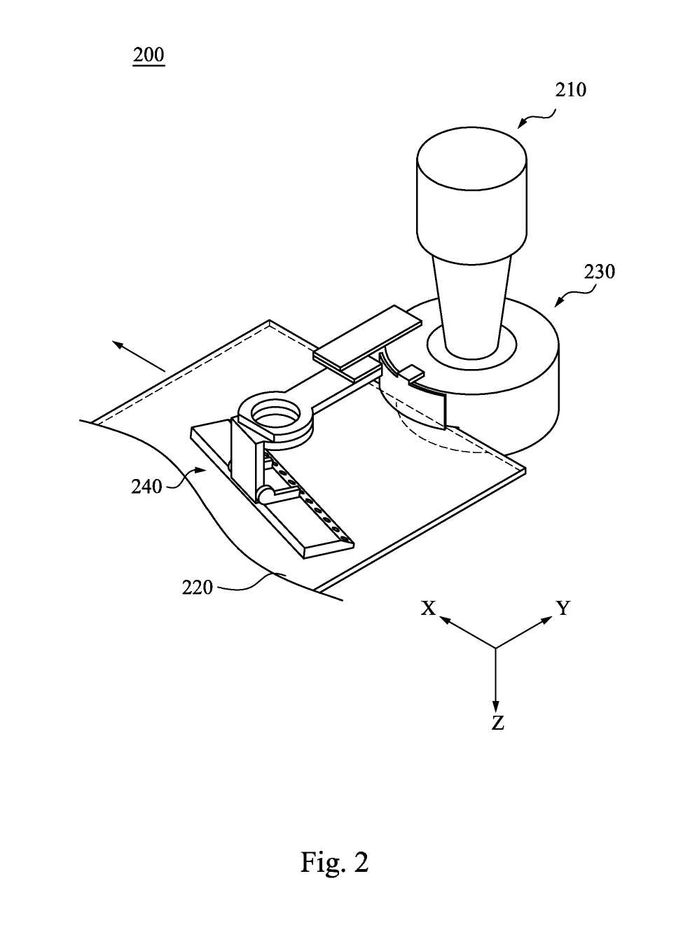

FIG. 2 shows an exemplary embodiment of a machining apparatus 200 for machining a glass sheet at a machining station. As shown in FIG. 2, the glass sheet 220 that is to be machined is in a substantially horizontal orientation. The glass sheet 220 extends substantially along the illustrated X-Y plane with the force of gravity acting in the Z direction. The glass sheet 220 is conveyed by a conveyor (not shown) along a direction as denoted by the arrow shown in FIG. 2 when being machined. In a further embodiment, the glass sheet 220 may be oriented at other orientations, for examples, may be oriented along the X-Z plane or Y-Z plane, and conveyed along another direction during the machining process.

As shown in FIG. 2, a motor unit 210 is coupled to a working wheel and configured to drive the working wheel for machining the glass sheet 220. In an embodiment, the working wheel is a grinding wheel for grinding an edge of the glass sheet. In another embodiment, the working wheel is a polishing wheel for polishing the glass sheet 220 after grinding process, or any other wheels used for machining the glass sheet 220. The working wheel is substantially circumscribed by a shroud 230. For example, the shroud 230 may be a cover made of stainless material. The shroud 230 is configured to receive a surface portion (e.g., edge portion) of the glass sheet 220 during the machining process and prevent the fragments or chips of glass generated by the machining process from spreading out over the machining area of the glass sheet 220 (e.g., near the edge of the glass sheet), such that the fragments or chips of glass are possibly retained inside the shroud 230. Further, during the machining process, a water knife 240 is provided to supply water flow to clean the glass sheet 220 by removing the fragments or chips of glass that are incidentally spread out over the shroud 230 and potentially adhered to the surface of the glass sheet 220.

However, since there is an area covered by the shroud 230 and the surface portion of the glass sheet 220 received by the shroud 230 during the machining process, the fragments or chips of glass generated by the machining process within the area could not be totally removed by the water knife 240. Rather, they would be retained inside the shroud 230, trapped at the surface of the glass sheet 220 and adhered to the glass sheet 220, adversely contaminating the glass sheet 220. The potential causes for trapping the fragments or chips of glass at the surface of the glass sheet 220 (i.e., adhered glass) include fluid flow stagnation inside the shroud 230, the interference between the water knife 240 and a coolant flow, and the direction of the coolant flow.

Thus, there is still a need for an apparatus and/or a method for cleaning the glass sheet prior to the washing process for the glass sheet on the production line, particularly, by removing the fragments or chips of glass that are covered by the shroud and could not be washed away by the water knife, so as to reduce the amounts of adhered glass due to the machining process.

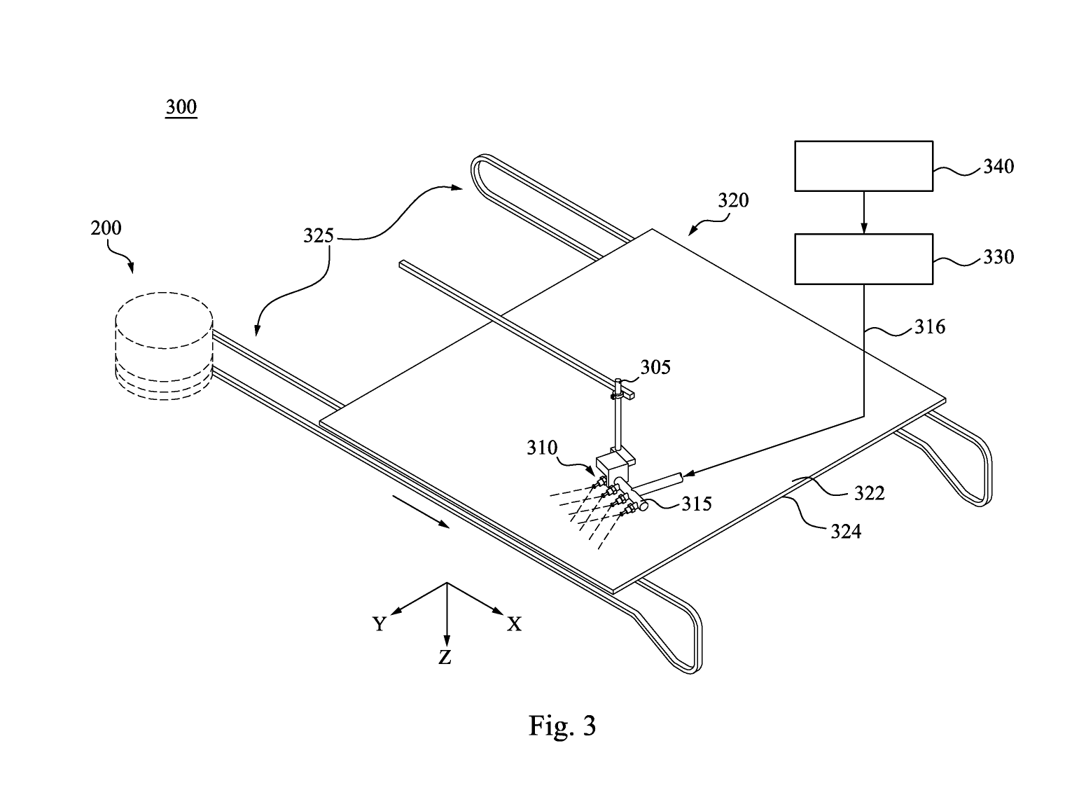

FIG. 3 illustrates a schematic view of a cleaning apparatus 300 for cleaning a glass sheet 320 according to an embodiment described herein. In an example embodiment, the glass sheet 320 is in a substantially horizontal orientation. The glass sheet 320 extends substantially along the illustrated X-Y plane with the force of gravity acting in the Z direction. During the cleaning process, the glass sheet 320 is conveyed by a conveyor 325 along the illustrated X direction as denoted by the arrow shown in FIG. 3. In further embodiments, the glass sheet 320 may be oriented at other orientations, for example, may be oriented along the X-Z plane or Y-Z plane, and conveyed along a Y or Z direction during the cleaning process.

As schematically illustrated in FIG. 3, the glass sheet 320 to be cleaned by the cleaning apparatus 300 has been subject to a machining process performed by the machining apparatus 200 at the machining station. In FIG. 3, the machining apparatus 200 is shown in dashed line and may correspond to the machining apparatus 200 shown in FIG. 2, in which a grinding process and/or a polishing process may be performed for the glass sheet 320. After undergoing the machining process, the glass sheet 320 is transferred to the cleaning apparatus 300 by the conveyor 325 and is conveyed along a conveyed direction, i.e., the direction denoted by the arrow in the X direction as shown in FIG. 3.

As embodied herein and depicted in FIG. 3, the cleaning apparatus 300 comprises a control unit 340 for controlling water supplied from a water supply 330, and a plurality of spraying devices 310 mounted on a manifold 315 for cleaning the glass sheet 320. The cleaning apparatus 300 further comprises a support 305 for supporting the manifold 315 as well as the plurality of spraying devices 310.

As shown in FIG. 3, in an embodiment, the plurality of spraying devices 310 are positioned away from, i.e., above, a first surface 322 of the glass sheet 320. The first surface 322 of the glass sheet 320 is defined as a major surface of the glass sheet 320 and in this case is facing upward (i.e., in the negative Z direction) as illustrated in FIG. 3. The plurality of spraying devices 310 are coupled to the water supply 330 and configured to spray water from the water supply 330 to the glass sheet 320. In an embodiment, the spraying devices 310 are for example, but not limited to, a plurality of nozzles. Any other spraying devices that can be used to spray water to the glass sheet 320 could also be utilized herein. Also, in FIG. 3, four spraying devices 310 are shown for the purpose of illustration, and any number of the spraying devices 310 can be utilized herein.

As shown in FIG. 3, the plurality of spraying devices 310 are mounted on the manifold 315 and coupled to the water supply 330 through a water pipeline 316. The water supply 330 provides water flow at high pressure and high velocity suitable for cleaning the glass sheet 320. In an embodiment, the water is supplied from the water supply 330 through a pressure pump with the capability of the pressure in a range from 0 kg/cm² to about 16 kg/cm². In an example embodiment, the water supply 330 may provide water flow at a pressure in a range from about 6 kg/cm² to about 16 kg/cm², for example in a range from about 8 kg/cm² to about 16 kg/cm², from about 10 kg/cm² to about 16 kg/cm², from about 12 kg/cm² to about 16 kg/cm², or from about 14 kg/cm² to about 16 kg/cm².

In an embodiment, the cleaning apparatus 300 may also comprise a filtration system (not shown) through which the water from the water supply 330 is flowed and filtrated, so as to provide clean water flow for the manifold 315 as well as the plurality of spraying devices 310.

The control unit 340 is configured to control the water supplied from the water supply 330, preferably, the filtrated water through the filtration system, into the manifold 315 and further into the plurality of spraying devices 310, such that the plurality of spraying devices 310 spray the cleaning water to the first surface 322 or major surface of the glass sheet 320. The control unit 340 is further configured to control ON and OFF timings for the water supplied from the water supply 330 using solenoids which are controlled by a programmable logic controller through the execution of programmable logic controller programs. That is, based on the programmable logic controller programs, the control unit 340 determines the time that the water supply 330 is turned on and/or the time that the water supply 330 is turned off.

In an embodiment, the cleaning apparatus 300 may further comprise a sensor (not shown) situated at an appropriate position on the production line. Once it is determined that a front edge of the glass sheet 320 transferred by the conveyor 325 has passed through a certain position sensed by the sensor, the water supply 330 can be turned on and then the cleaning water flows from the water supply 330 into the plurality of spraying devices 310, which then spray water and clean the glass sheet 320. Further, when it is determined that a rear edge of the glass sheet 320 transferred by the conveyor 325 has passed through the certain position sensed by the sensor, the water supply 330 can be turned off so as to save the water consumption.

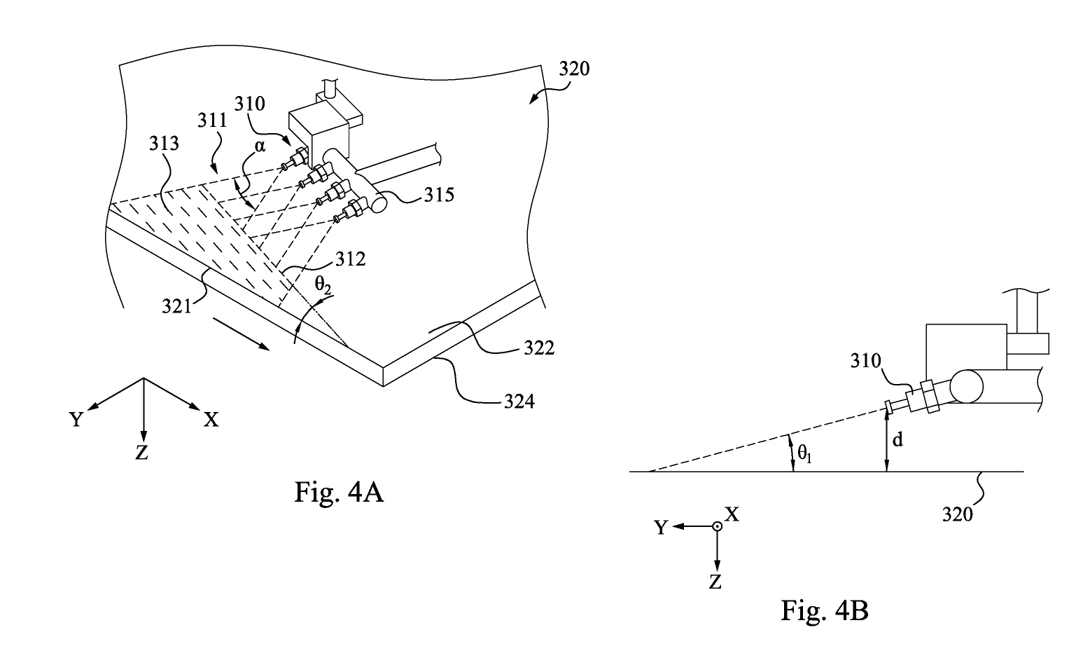

FIG. 4A schematically illustrates a close-up view of the cleaning apparatus 300 of FIG. 3 according to an embodiment described herein, and FIG. 4B is a schematic side view of FIG. 4A. Referring to FIGS. 4A and 4B, the plurality of spraying devices 310 are each positioned away from, i.e., above, the first surface 322 of the glass sheet 320 in a tilt angle with respect to the first surface 322 of the glass sheet 320. Specifically, as best shown in FIG. 4B, the plurality of spraying devices 310 are each positioned in a first angle θ₁ measured from the first surface of the glass sheet 320. It is found that the plurality of spraying devices 310 that are each positioned in a first angle θ₁ being larger than 30 degrees may deliver high fluid pressure on the glass sheet 320 and may cause the risk of surface scratch. In an embodiment, the first angle θ₁ is in a range from about 10 degrees to about 20 degrees, for example in a range from about 10 degrees to about 18 degrees, from about 10 degrees to about 16 degrees, in a range from about 10 degrees to about 14 degrees or in a range from about 10 degrees to about 12 degrees. In another embodiment, the first angle θ₁ is preferably 10 degrees.

Besides, the plurality of spraying devices 310 each are spaced from the first surface of the glass sheet 320 by a distance so as not to contact and scratch the surface of the glass sheet 320. In an embodiment, the plurality of spraying devices 310 are a plurality of nozzles and preferably, the distance d between a tip of the plurality of nozzles and the first surface 322 of the glass sheet 320 is in a range from about 20 mm to about 30 mm. Preferably, the distance d is substantially 25 mm. However, other distances may be utilized to achieve specific efficacy requirements based on spray pattern, fluid pressure, spray angle and the like.

As embodied herein and depicted in FIG. 4A, the plurality of spraying devices 310 spray water from the water supply (see water supply 330 in FIG. 3) in a plurality of spraying sections 311 at the first angle θ₁ (see FIG. 4B) over an edge 321 of the glass sheet 320, the edge 321 being parallel to the conveyed direction, i.e., the illustrated X direction as denoted by the arrow shown in FIG. 3. In an embodiment, the plurality of spraying devices 310 may be a plurality of nozzles, and the plurality of spraying sections 311 each are substantially sectors extended by an angle α determined by, for example, the type of the nozzles utilized. For example, the angle α is in a range from about 60 degrees to about 70 degrees. In an embodiment, the angle α is substantially 65 degrees.

The plurality of spraying sections 311 formed by the plurality of spraying devices 310 intersect the first surface 322 of the glass sheet 320 at a spraying line 312, thereby forming a cleaning zone 313 on the first surface 322 of the glass sheet 320. As shown in FIG. 4A, the spraying line 312 on the first surface 322 of the glass sheet 320 and the edge 321 of the glass sheet 320 form a second angle θ₂, wherein the edge 321 is parallel to the conveyed direction. In an embodiment, the second angle θ₂ is in the range from about 10 degrees to about 30 degrees, and includes all ranges and sub-ranges therebetween. In an example embodiment, the second angle θ₂ is preferably 20 degrees.

In this way, when the glass sheet 320 is conveyed in the positive X direction and the spraying line 312 of the plurality of spraying devices 310 forms a second angle θ₂ with the edge 321 of the glass sheet 320, the fragments or chips of glass or any other particles that may be generated due to the machining of the glass sheet 320 inside the cleaning zone 313 on the glass sheet 320 can be washed away in a direction substantially along the positive Y axis direction. In an embodiment, a longest distance between the spraying line 312 and the edge 321 of the glass sheet 320 is in a range from about 100 mm to about 150 mm, includes all ranges and sub-ranges there between, such that most of the fragments or chips of glass inside the cleaning zone 313 could be removed from the glass sheet 320.

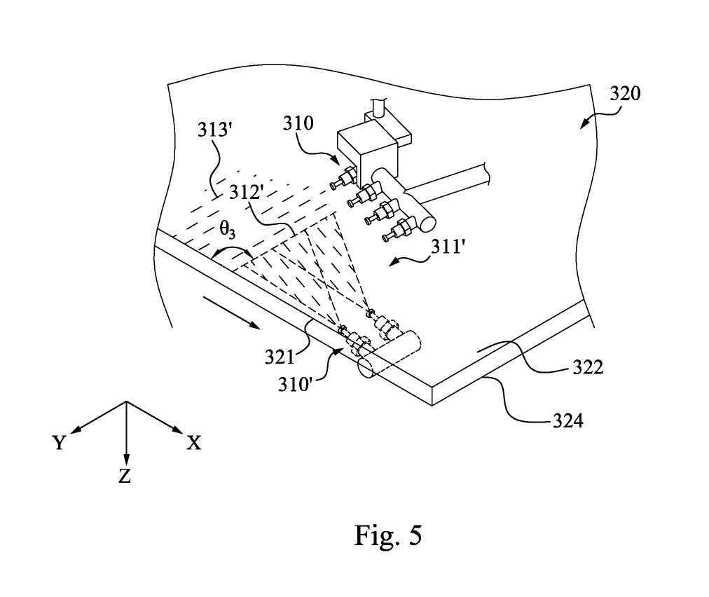

FIG. 5 schematically illustrates a close-up view of a cleaning apparatus 300 according to another embodiment described herein. As embodied herein and depicted in FIG. 5, in addition to the plurality of spraying devices 310 positioned away from, i.e., above, the first major surface 322 of the glass sheet 320 as shown in FIG. 3, the cleaning apparatus 300 in FIG. 5 may further comprise a plurality of spraying devices 310′ coupled to and in fluid communication with the water supply 330 (see FIG. 3) and positioned away from, i.e., below, a second surface 324 of the glass sheet 320, the second surface 324 being opposite to the first major surface 322 of the glass sheet 320.

As shown in FIG. 5, similarly, the plurality of spraying devices 310′ may each be positioned, away from, i.e. below, the second surface 324 of the glass sheet 320, in the same first angle θ₁ measured from the second surface 324 of the glass sheet 320. In example embodiments, the first angle θ₁ may be in a range from about 10 degrees to about 20 degrees, for example in a range from about 10 degrees to about 18 degrees, from about 10 degrees to about 16 degrees, in a range from about 10 degrees to about 14 degrees or in a range from about 10 degrees to about 12 degrees. In another embodiment, the first angle θ₁ is preferably 10 degrees. In an example embodiment, the plurality of spraying devices 310′ are a plurality of nozzles and the distance d between a tip of the plurality of nozzles and the second surface 324 of the glass sheet 320 is in a range from about 20 mm to about 30 mm. For example, the distance d is substantially 25 mm.

As embodied herein and depicted in FIG. 5, the control unit 340 (see FIG. 3) is further configured to supply the water from the water supply 330 (see FIG. 3) into the plurality of spraying devices 310′, such that the plurality of spraying devices 310′ spray water from the water supply 330 in a plurality of spraying sections 311′ at the first angle θ₁ over the edge 321 of the glass sheet 320. As described above, the edge 321 is parallel to the conveyed direction, i.e., the illustrated X direction as denoted by the arrow shown in FIG. 3. In an embodiment, the plurality of spraying devices 310′ are a plurality of nozzles, and the plurality of spraying sections 311′ each are substantially sectors extended by an angle α determined by, for example, the type of the nozzles utilized. For example, the angle α is in a range from about 60 degrees to about 70 degrees. In an embodiment, the angle α is substantially 65 degrees.

The plurality of spraying sections 311′ formed by the plurality of spraying devices 310′ intersect the second surface 324 of the glass sheet 320 at a spraying line 312′, thereby forming a cleaning zone 313′ on the second surface 324 of the glass sheet 320. As shown in FIG. 5, the spraying line 312′ on the second surface 324 of the glass sheet 320 and the edge 321 of the glass sheet 320 form a third angle θ₃, wherein the edge 321 is parallel to the conveyed direction. In an example embodiment, the third angle θ₃ is substantially 90 degrees, for example in a range from about 85 degrees to about 95 degrees.

Thus, with the plurality of spraying devices 310 and 310′ positioned respectively away from, i.e., above and below, the first and second surfaces 322, 324 of the glass sheet 320, the fragments or chips of glass or any other particles that may be generated and spread over the edge of the glass sheet 320 can be effectively and efficiently washed away from the glass sheet 320, so as to reduce the possibility of forming adhered glass to the first and second surfaces 322, 324 of the glass sheet 320.

The possibility of forming adhered glass to one major surface of the glass sheet due to machining of the glass sheet may be larger than that to the opposite major surface of the glass sheet because a large portion of the fragments or chips of glass would spread out over the first major surface of the glass sheet and the fragments or chips of glass spread out over the opposite major surface of the glass sheet may be drawn away by the action of gravity. In an embodiment, both the plurality of spraying devices 310 and 310′ are a plurality of nozzles, and the number of the plurality of nozzles positioned above the first major surface of the glass sheet 320 may be designed to be larger than the number of the second plurality of nozzles positioned below the second major surface of the glass sheet 320, so as to enhance the cleaning efficiency for the first major surface of the glass sheet 320.

A method for cleaning a glass sheet moving along a conveyed direction is also disclosed herein. The method comprises positioning a plurality of spraying devices 310 coupled to and in fluid communication with a water supply 330 away from, i.e., above, a first surface 322 of the glass sheet 320 in a first angle θ₁ measured from the first surface 322 of the glass sheet 320. The method may further comprise spraying, through the plurality of spraying devices 310, water from the water supply 330 in a plurality of spraying sections 311 at the first angle θ₁ over an edge 321 of the glass sheet 320, thereby forming a first cleaning zone 313 on the first surface 322 of the glass sheet 320. The plurality of the spraying sections 311 intersect the first surface 322 of the glass sheet 320 at a spraying line 312, and the spraying line 312 and the edge 321 of the glass sheet 320 form a second angle θ₂, with the edge 321 being parallel to the conveyed direction.

The method may further comprise positioning a plurality of spraying devices 310′ coupled to and in fluid communication with the water supply 330 away from, i.e., below, a second surface 324 of the glass sheet 320 in the first angle θ₁ measured from the second surface 324 of the glass sheet 320; and spraying, through the plurality of spraying devices 310′, the water in a plurality of spraying sections 311′ at the first angle θ₁ over the edge 321 of the glass sheet 320, thereby forming a second cleaning zone 313′ on the second surface 324 of the glass sheet 320. The plurality of spraying sections 311′ intersect the second surface 324 of the glass sheet 320 at a spraying line 312′, wherein the spraying line 312′ and the edge 321 of the glass sheet 320 form a third angle θ₃.

The above descriptions are directed to the cleaning of the edge 321 of the glass sheet 320 after machining the edge 321 of the glass sheet 320 at the machining station and before the glass sheet 320 is further conveyed to a subsequent washing station on the production line. Particularly, after the edge 321 of the glass sheet 320 is machined, the glass sheet 320 is conveyed and the cleaning process is conducted on the glass sheet 320 as soon as possible, for example, within about 5 seconds. Compared to the time it takes for transferring the glass sheet 320 from the machining station to the washing station on the production line, which is usually about 60 seconds, the time elapsed after machining is greatly reduced, and the fragments or chips of glass can be washed away as quickly as possible, thereby reducing the possibility of forming adhered glass to the glass sheet.

Moreover, the remaining edges of the glass sheet 320 can be cleaned based on the same cleaning apparatus and method after being subjected to a machining process as discussed above. For example, another edge of the glass sheet 320 can be cleaned using the same cleaning apparatus 300 via 90 degrees rotation of the glass sheet 320 after the cleaning of the edge 321 is completed. In another embodiment, a further cleaning apparatus having the same or similar design with the cleaning apparatus 300 may be provided, such that the cleaning of two edges of the glass sheet 320 can be conducted simultaneously or successively.

### EXAMPLES

Various embodiments will be further clarified by the following examples.

### Example 1

In this example, Standard Flat Spray Nozzles of type No. 6540 (spray angle being 65° under 0.3 Mpa and spray capacity being 4.00 L/min under 0.3 Mpa) available from Ikeuchi Taiwan Co., Ltd were mounted on a manifold and utilized to spray water from the water supply such that spraying sections were substantially sectors extended by an angle α of about 65°. The nozzle of type No. 6540 utilized in this example had a free pass diameter of 1.3 mm and a hole area of 1.3273 mm². The water supply provided water flow at the pressure of about 8 kg/cm². Each nozzle of type No. 6540 had the flow rate of 6.65 L/min and the speed of the water flow was 83 m/sec.

Four nozzles of type No. 6540 were positioned above a first major surface of the glass sheet in a first angle θ₁ about 20° measured from the first surface of the glass sheet, and a distance between a tip of the nozzles and the first surface of the glass sheet was about 25 mm. The four nozzles sprayed water from the water supply in the spraying sections at the angle of about 20° over an edge of the glass sheet. The spraying sections intersected the first surface of the glass sheet at a spraying line, and the spraying line and the edge of the glass sheet formed a second angle θ₂ of about 20°. Accordingly, a cleaning zone on the first surface of the glass sheet was formed and a longest distance between the spraying line and the edge of the glass sheet was about 140 mm.

Also, two nozzles of type No. 6540 were positioned below a second or opposite surface of the glass sheet in the first angle θ₁ of about 20° measured from the second surface of the glass sheet, and a distance between a tip of the nozzles and the second surface of the glass sheet was also about 25 mm. The two nozzles sprayed water from the water supply in the spraying sections at an angle of about 20° over the edge of the glass sheet. The spraying sections intersected the second surface of the glass sheet at a spraying line, and the spraying line and the edge of the glass sheet formed a third angle θ₃ of about 90°.

The measurement results of adhered glass on both surfaces of the glass sheet are shown in Table 1. The density of adhered glass on one surface of the glass sheet is defined as the amount of adhered glass per meter square (#/m²).

TABLE 1
The measurement results of adhered glass under different conditions.

| | | Water knife | Water knife cleaning |
|---|---|---|---|
| | | cleaning at | at machining station |
| | | machining | & cleaning |
| Conditions | Baseline | station only | based on Example 1 |
| Pieces of glass sheet tested | 2420 pcs | 2510 pcs | 2508 pcs |
| Adhered glass density on the | 0.0104 | 0.0073 | 0.0020 |
| first surface (#/m²) | | | |
| Adhered glass density on the | 0.0262 | 0.0107 | 0.0120 |
| second surface (#/m²) | | | |

It can be seen from Table 1 that, under the condition that the glass sheet was subject to water knife cleaning at machining station as well as cleaning based on Example 1, compared with the baseline (i.e., no cleaning at all), the adhered glass density on the first surface of the glass sheet shows 80.77% reduction, and the adhered glass density on the second surface of the glass sheet shows 54.2% reduction. That is, the water knife cleaning at the machining station combined with the cleaning technology as disclosed herein significantly reduced the adhered glass density on the first major surface of the glass sheet subject to machining processes. Particularly, the adhered glass density on the first major surface of the glass sheet achieved the target of being 0.0020 (#/m²).

### Example 2

In this example, Standard Flat Spray Nozzles of type No. 6510 (spray angle being 65° under 0.3 Mpa and spray capacity being 1.00 L/min under 0.3 Mpa) available from Ikeuchi Taiwan Co., Ltd were mounted on a manifold and utilized to spray water from the water supply such that spraying sections were substantially sectors extended by an angle α of about 65°. The nozzle of type No. 6510 differs from the nozzle of type No. 6540 in that the former has a smaller free pass diameter and a hole area, and thus a higher speed of the water flow. The nozzle of type No. 6510 utilized in this example had a free pass diameter of 0.6 mm and a hole area of 0.2827 mm². The water supply provided water flow at the pressure of about 8 kg/cm². Each nozzle of type No. 6510 had the flow rate of 1.63 L/min and the speed of the water flow was 96 m/sec. Compared with the nozzle of type No. 6540, the nozzle of type No. 6510 had the advantage of reduced water consumption of about 74.96%.

In this example, four nozzles of type No. 6510 were positioned above a first major surface of the glass sheet in a first angle θ₁ of about 10° measured from the first surface of the glass sheet, and a distance between a tip of the nozzles and the first surface of the glass sheet was about 25 mm. The four nozzles sprayed water from the water supply in the spraying sections at the angle of about 10° over an edge of the glass sheet. The spraying sections intersected the first surface of the glass sheet at a spraying line, and the spraying line and the edge of the glass sheet formed a second angle θ₂ of about 20°. Accordingly, a cleaning zone on the first surface of the glass sheet was formed and a longest distance between the spraying line and the edge of the glass sheet was in the range from about 120 mm to about 150 mm.

Also, two nozzles of type No. 6510 were positioned below a second or opposite surface of the glass sheet in the first angle θ₁ of about 10° measured from the second surface of the glass sheet, and a distance between a tip of the nozzles and the second surface of the glass sheet was also about 25 mm. The two nozzles sprayed water from the water supply in the spraying sections at the first angle of about 10° over the edge of the glass sheet. The spraying sections intersected the second surface of the glass sheet at a spraying line, and the spraying line and the edge of the glass sheet formed a third angle θ₃ of about 90°.

In this example, the water knife cleaning at the machining station was turned off. The measurement results of adhered glass on both surfaces of the glass sheet are shown in Table 2.

TABLE 2
The measurement results of adhered glass under different conditions.

| | | Cleaning based |
|---|---|---|
| Conditions | Baseline | on Example 2 |
| Pieces of glass sheet tested | 1261 pcs | 1247 pcs |
| Adhered glass density on the first | 0.0110 | 0.0064 |
| surface (#/m²) | | |
| Adhered glass density on the second | 0.0058 | 0.0023 |
| surface (#/m²) | | |

It can be seen from Table 2 that, under the condition that the glass sheet was subject to the cleaning based on Example 2, compared with the baseline (i.e., no cleaning at all), the adhered glass density on the first and second surfaces of the glass sheet as a whole shows 47.9% reduction. That is, the cleaning technology as disclosed herein significantly reduced the adhered glass density on the both surfaces of the glass sheet subjected to machining processes. Particularly, the adhered glass density on the second major surface of the glass sheet achieved the target of being 0.0023 (#/m²).

Thus, the cleaning apparatus and method for cleaning the glass sheet as disclosed herein can significantly reduce the amount of defects such as adhered glass to the glass sheet resulting from the machining of the glass sheet at a machining station. The cleaning apparatus and method disclosed herein can arrive at the target of adhered glass density measured on the major surface of the glass sheet being less than about 0.004 #/m², preferably, less than about 0.002 #/m².

Further, the cleaning apparatus disclosed herein can be retrofitted to a variety of production conditions without needing to redesign a production line, and thus more economically and efficiently clean the glass sheet so as to reduce the defects of the glass sheet.

It is noted that the term “substantially” may be utilized herein to represent the inherent degree of uncertainty that may be attributed to any quantitative comparison, value, measurement, or other representation. This term is also utilized herein to represent the degree by which a quantitative representation may vary from a stated reference without resulting in a change in the basic function of the subject matter at issue.

Various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. An apparatus for cleaning a glass sheet moving along a conveyed direction, comprising:
a first plurality of spraying devices coupled to a water supply and positioned away from a first surface of the glass sheet in a first angle measured from the first surface of the glass sheet; and
a control unit configured to supply water from the water supply into the first plurality of spraying devices such that the first plurality of spraying devices spray water from the water supply in a first plurality of spraying sections at the first angle over an edge of the glass sheet, thereby forming a first cleaning zone on the first surface of the glass sheet, wherein the first plurality of the spraying sections intersect the first surface of the glass sheet at a first spraying line, the first spraying line and the edge of the glass sheet form a second angle, and the edge is parallel to the conveyed direction.

2. The apparatus of claim 1, wherein the first plurality of spraying devices comprise a first plurality of nozzles, and the first plurality of spraying sections are sectors in a range from about 60 degrees to about 70 degrees.

3. (canceled)

4. The apparatus of claim 2, wherein a distance between a tip of the first plurality of nozzles and the first surface of the glass sheet is in a range from about 20 mm to about 30 mm.

5. (canceled)

6. The apparatus of claim 1, wherein the first angle is in a range from about 10 degrees to about 20 degrees.

7. The apparatus of claim 1, wherein the second angle is in a range from about 10 degrees to about 30 degrees.

8. (canceled)

9. The apparatus of claim 1, wherein a distance between the first spraying line and the edge of the glass sheet is in a range of about 100 mm to about 150 mm.

10. The apparatus of claim 1, further comprising:
a second plurality of spraying devices fluidly coupled to the water supply and positioned away from a second surface of the glass sheet in the first angle measured from the second surface of the glass sheet,
wherein the control unit is further configured to supply the water from the water supply into the second plurality of spraying devices such that the second plurality of spraying devices spray the water in a second plurality of spraying sections at the first angle over the edge of the glass sheet, thereby forming a second cleaning zone on the second surface of the glass sheet,
wherein the second plurality of spraying sections intersect the second surface of the glass sheet at a second spraying line, the second spraying line and the edge of the glass sheet form a third angle.

11. The apparatus of claim 10, wherein the third angle is in a range from about 85 degrees to about 95 degrees.

12. (canceled)

13. The apparatus of claim 10, wherein the second plurality of spraying devices comprise a second plurality of nozzles, the second plurality of spraying sections are sectors in a range from about 60 degrees to about 70 degrees, and a distance between a tip of the second plurality of nozzles and the second surface of the glass sheet is in a range from about 20 mm to about 30 mm.

14-15. (canceled)

16. The apparatus of claim 13, wherein a number of the first plurality of nozzles is larger than a number of the second plurality of nozzles.

17. The apparatus of claim 1, further comprising:
a conveyor for delivering the glass sheet along the conveyed direction.

18. A method for cleaning a glass sheet moving along a conveyed direction, comprising:
positioning a first plurality of spraying devices coupled to a water supply away from a first surface of the glass sheet in a first angle measured from the first surface of the glass sheet; and
spraying, through the first plurality of spraying devices, water from the water supply in a first plurality of spraying sections at the first angle over an edge of the glass sheet, thereby forming a first cleaning zone on the first surface of the glass sheet, wherein the first plurality of the spraying sections intersect the first surface of the glass sheet at a first spraying line, the first spraying line and the edge of the glass sheet form a second angle, and the edge is parallel to the conveyed direction.

19. The method of claim 18, wherein the first plurality of spraying devices comprise a first plurality of nozzles, and the first plurality of spraying sections are sectors in a range from about 60 degrees to about 70 degrees.

20. (canceled)

21. The method of claim 19, wherein a distance between a tip of the first plurality of nozzles and the first surface of the glass sheet is in a range from about 20 mm to about 30 mm.

22. (canceled)

23. The method of claim 18, wherein the first angle is in a range from about 10 degrees to about 20 degrees.

24. The method of claim 18, wherein the second angle is in a range from about 10 degrees to about 30 degrees.

25. (canceled)

26. The method of claim 18, wherein a distance between the first spraying line and the edge of the glass sheet is in a range of about 100 mm to about 150 mm.

27. The method of claim 18, further comprising:
positioning a second plurality of spraying devices coupled to the water supply away from a second surface of the glass sheet in the first angle measured from the second surface of the glass sheet; and
spraying, through the second plurality of spraying devices, the water in a second plurality of spraying sections at the first angle over the edge of the glass sheet, thereby forming a second cleaning zone on the second surface of the glass sheet, wherein the second plurality of spraying sections intersect the second surface of the glass sheet at a second spraying line, the second spraying line and the edge of the glass sheet form a third angle.

28. The method of claim 27, wherein the third angle is in a range from about 85 degrees to about 95 degrees.

29. (canceled)

30. The method of claim 27, wherein the second plurality of spraying devices comprises a second plurality of nozzles, the second plurality of spraying sections are sectors in a range from about 60 degrees to about 70 degrees, and a distance between a tip of the second plurality of nozzles and the second surface of the glass sheet is in a range from about 20 mm to about 30 mm.

31-32. (canceled)

33. The method of claim 30, wherein a number of the first plurality of nozzles is larger than a number of the second plurality of nozzles.
